(19) United States
(12) Patent Application Publication
(10) Pub. No.: US 2014/0000121 A1
(43) Pub. Date: Jan. 2, 2014

(54) Lobster Gauge

(71) Applicant: Great Gauges, Inc., North Bay Village, FL (US)

(72) Inventor: Diana Reed, North Bay Village, FL (US)

(21) Appl. No.: 13/925,974

(22) Filed: Jun. 25, 2013

Related U.S. Application Data
(60) Provisional application No. 61/666,855, filed on Jun. 30, 2012.

(51) Int. Cl. G01B 5/02

(52) U.S. Cl. CPC G01B 5/02
USPC 33/511

(57) ABSTRACT

An apparatus for measuring a section of a creature, the apparatus having a caliper with a slot, a band for anchoring the caliper, and a tether to connect the caliper and the band. The tether may have a first and second loop to connect to the caliper and band. The slot width is configurable respective to a desired length of the section of the creature measured. The apparatus is constructed using corrosion resistant substances. A method is provided for using the same to measure a section of a creature. In one example, a lobster gauge is provided to measure a carapace for determining compliance with governmental regulations.

### CROSS-REFERENCE TO RELATED APPLICATION

This application claims the priority from U.S. provisional patent application Ser. No. 61/666,855 filed Jun. 30, 2012. The foregoing application is incorporated in its entirety herein by reference.

### FIELD OF THE INVENTION

The invention relates to measuring devices. More particularly, the invention relates to devices used to measure an aquatic animal.

### BACKGROUND

Throughout much of human history, people have enjoyed fishing. Many fishermen desire to take some of their catch home with them, so that it may be prepared into a meal. Fishing can generally include catching aquatic animals such fish, shellfish, cephalopods, arthropods, crustaceans, and echinoderms.

Due to the popularity of fishing, and the desire to preserve various species of aquatic animals that are typically fished, restrictions are often placed on the types and sizes of aquatic animals that can be caught. For example, in Florida of the United States, as of 2012, the Florida Lobster has a quantity limit of typically six catches allowed per day during regular season, depending on the area of Florida in which the lobster is caught. Additionally, a size limit has been placed on the Florida lobsters, requiring that the carapace of the lobster be three inches or larger while measured in the water. Other regions through out the world carry similar or other restrictions.

Tools have been created to measure the lobster. Regular rulers or tape measures may be used, but could be unwieldy or inconvenient to use. Some fishermen attempt to construct their own tools, but such tool may lack precision and require a substantial investment of time and effort to create. Additionally, many tools may be prone to being dropped while in the water and sinking to an unrecoverable depth.

What is needed is a tool to quickly and easily measure the size of an aquatic creature. What is also needed is a tool that is securable to a person, to resist being lost during use.

### SUMMARY

According to embodiments of the present invention, a lobster gauge is described that may include at least a caliper, a tether, and a band. The tether may connect the caliper and the band. According to at least one embodiment of the present invention, the lobster gauge may allow a person to measure the size of an aquatic creature quickly and easily. The lobster gauge, according to at least one embodiment of the present invention, may also be securable to the person, to resist being lost during use.

According to an embodiment of the present invention, an apparatus is provided for measuring a section of a creature. The apparatus may include a caliper with a slot, a band, and a tether. The caliper may include a top edge and opposing bottom edge extending from a first end of the caliper to a second end of the caliper. The caliper may also include caliper material extending from the top edge to the bottom edge being bound at the first end by a first side edge and at the second end by a second side edge. A slot of caliper material absent from the caliper at the top edge may be defined by a slot width along part of the top edge partially extending into the caliper material of the caliper in the direction of the bottom edge to a slot depth and terminating at a bottom slot edge. The band may anchor the caliper, for example, to an object or user.

The tether may connect the caliper and the band. The tether may include a piece of tether material elongated between a first tether end and a distal second tether end. The first tether end may be connected to a first intermediary section of the tether to form a first loop that is connectable to the caliper. The second tether end may be connected to a second intermediary section of the tether to form a second loop that is connectable to the band. The tether is connectable to the caliper via a hole in the caliper. The slot width may be configurable respective to a desired length of the section of the creature.

In another aspect, the top edge may be approximately parallel with the bottom edge. In another aspect, the first side edge may be approximately parallel with the second side edge.

In another aspect, the top edge may be approximately parallel with the bottom edge, the first side edge may be approximately parallel with the second side edge, and the top edge and the bottom edge may be approximately orthogonal to the first side edge and the second side edge.

In another aspect, the top edge or the bottom edge may intersect with the first side edge or the second side edge at a corner that is at least partially rounded.

In another aspect, the apparatus is constructed using corrosion resistant substances.

In another aspect, the slot width is adjustable.

In another aspect, the apparatus may include a ring passable through the first loop and the hole to connect the tether to the caliper.

In another aspect, the section may be a carapace and the creature may be an arthropod.

According to an embodiment of the present invention, an apparatus is provided for measuring a section of a creature. The apparatus may include a caliper with a slot, a band, and a tether. The caliper may include a top edge and opposing bottom edge extending from a first end of the caliper to a second end of the caliper. The caliper may include caliper material extending from the top edge to the bottom edge being bound at the first end by a first side edge and at the second end by a second side edge. The top edge may be approximately parallel with the bottom edge. Additionally, the first side edge may be approximately parallel with the second side edge. The top edge and the bottom edge may be approximately orthogonal to the first side edge and the second side edge.

The slot of caliper material that is absent from the caliper at the top edge may be defined by a slot width along part of the top edge partially extending into the caliper material of the caliper in the direction of the bottom edge to a slot depth and terminating at a bottom slot edge.

The apparatus may include the band for anchoring the caliper, for example to an object or user. The tether may connect the caliper and the band. The tether may be connectable to a hole in the caliper. The slot width may be configurable respective to a desired length of the creature. The apparatus may be constructed using corrosion resistant substances.

In another aspect, the tether may include a piece of tether material elongated between a first tether end and a distal second tether end. The first tether end may be connected to a first intermediary section of the tether to form a first loop that is connectable to the caliper. The second tether end may be connected to a second intermediary section of the tether to form a second loop that is connectable to the band.

In another aspect, the top edge or the bottom edge intersect with the first side edge or the second side edge at a corner that is at least partially rounded.

In another aspect, the slot width may be adjustable.

In another aspect, the apparatus may include a ring that is passable through the first loop and the hole to connect the tether to the caliper.

According to an embodiment of the present invention, a method aspect is provided for measuring a section of a creature using an apparatus having a caliper with a slot. The method may include positioning the creature adjacent to the caliper. The caliper may have a top edge and opposing bottom edge extending from a first end of the caliper to a second end of the caliper. The caliper may also have caliper material extending from the top edge to the bottom edge being bound at the first end by a first side edge and at the second end by a second side edge.

The method may also include determining validity of the creature that has the section measured to equal or greater to the slot width. The slot may be caliper material that is absent from the caliper at the top edge defined by the slot width along part of the top edge partially extending into the caliper material in the direction of the bottom edge to a slot depth and terminating at a bottom slot edge.

The method may also include keeping the creature that is valid. Similarly, the method may include releasing the creature that is not valid. The caliper is capable of being anchored via a band.

The band is attachable to the caliper via a tether. The tether may include a piece of tether material elongated between a first tether end and a distal second tether end. The first tether end may be connected to a first intermediary section of the tether to form a first loop that is connectable to the caliper. The second tether end may be connected to a second intermediary section of the tether to form a second loop that is connectable to the band. The apparatus may include a hole in the caliper to which the tether is connectable. The slot width may be configurable respective to a desired length of the section of the creature indicative of validity.

In another aspect of the method, the top edge is approximately parallel with the bottom edge.

In another aspect of the method, the first side edge may be approximately parallel with the second side edge.

In another aspect of the method, the apparatus may be constructed using corrosion resistant substances.

In another aspect of the method, the slot width may be adjustable.

In another aspect of the method, the apparatus may include a ring that is passable through the first loop and the hole to connect the tether to the caliper.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a perspective view of the lobster gauge, according to an embodiment of the present invention.

FIG. 2 is a top plan view of the caliper, according to an embodiment of the present invention.

FIG. 3 is a top plan view of the tether, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings. In the following description, a lobster gauge will be discussed. Those of skill in the art will appreciate alternative labeling of the lobster gauge as a gauge, measuring device, measuring tool, device, tool, apparatus, the invention, or other similar names. Skilled readers should not view the inclusion of any alternative labels as limiting in any way.

Additionally, throughout this disclosure, the lobster gauge will be discussed in the context of measuring a lobster. More specifically, an embodiment of the present invention will be discussed in the context of measuring a Florida spiny lobster. Those of skill in the art will appreciate additional embodiments of the present invention which may be adapted to measure other aquatic animals. Additional embodiments of the present invention may be used to measure other creatures, which may or may not be aquatic. For example, without limitation, additional embodiments of the present invention may be used to measure Maine lobsters, various species of fish, crabs, arthropods, crustaceans, sea creatures, or other creatures that may be hunted or fished. Additionally, the present invention may be used to measure other objects, which may or may not be a living creature.

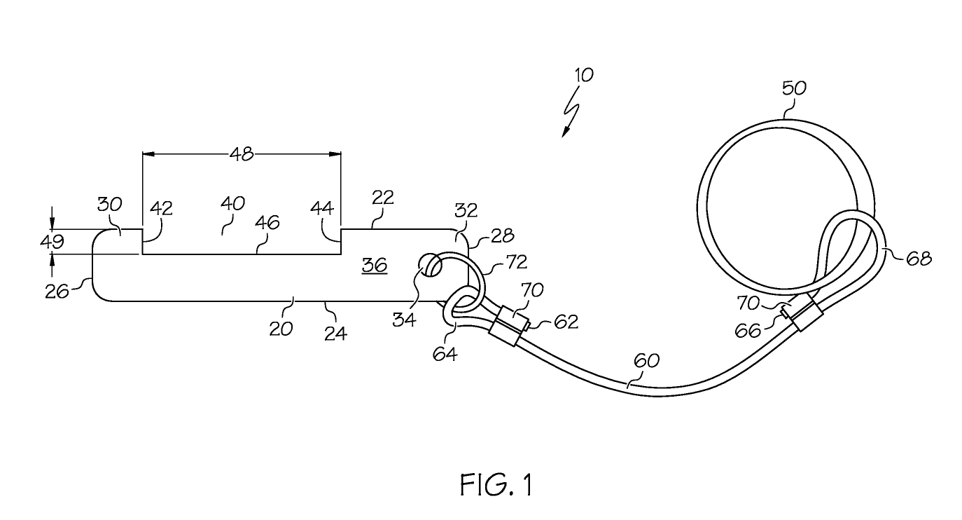

Referring now to FIGS. 1-3, a lobster gauge 10 will now be discussed. The lobster gauge 10 may include a number of components, which together may be used to measure a lobster while the lobster gauge 10 is connected to a person. The lobster gauge 10 may include a caliper 20, a band 50, and a tether 60. The caliper 20 may be connected to the band 50 by the tether 60. These components may generally be constructed with materials that are resistant to corrosion or deterioration from the environment in which they may be used. For example, the lobster gauge may be made or constructed of materials that are resistant to corrosion that could be caused by exposure to salt water.

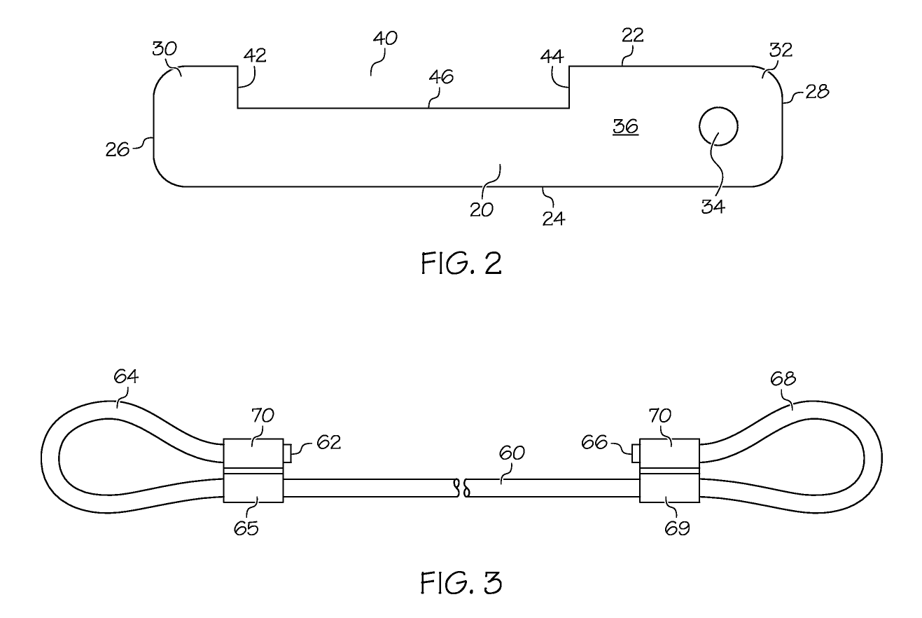

The caliper 20 will now be discussed in greater detail. As illustrated in FIGS. 1-2, the caliper 20 may be an elongated length of caliper material 36. However, a person of skill in the art will appreciate that the caliper 20 may be configured in shapes and sizes other than shown in FIGS. 1-2. The example caliper 20, as shown, may include a top edge 22 and an opposing bottom edge 24 located approximately horizontally at the top and bottom of the caliper 20, respectively. The top and bottom edges 22, 24 may be substantially parallel. The caliper 20 may also include a first side edge 26 and a second side edge 28 located approximately vertically at the opposing sides of the caliper 20. The first and second side edges 26, 28 may also be substantially parallel.

The bottom edge 24 may run a length substantially between the first side edge 26 and the second side edge 28. The top edge 22 may also run substantially between the first side edge 26 and the second side edge 28, with the exception of a slot 40, which will be discussed in greater detail below.

Two edges, for example the top edge 22 and the first side edge 26, may meet at a corner definable by an approximately orthogonal angle. The approximately orthogonal corners may create a substantially rectangular shape. Skilled artisans will appreciate that additional shapes may be used to create the caliper 20.

The corners of the edges may be at least partially rounded. Rounding of the edges may increase comfort for a user while holding the caliper 20. Additionally, rounded edges may decrease the amount of caliper material 36 required to construct the caliper 20, potentially reducing weight and manufacturing costs. Those of skill in the art will appreciate various embodiments of the present invention that may or may not include rounded edges, which are also intended to be included within the scope of the invention.

A slot 40 may be included by the caliper 20, which can be used to measure an aquatic creature, such as a lobster. The slot 40 may be an area of the caliper 20 from which material is absent or removed. The slot 40 may be located adjacent to the top edge 22 of the caliper 20, as illustrated in FIGS. 1 and 2. However, it should be apparent that the slot 40 may be located adjacent to other edges, such as the bottom edge 24, without limitation.

The slot 40 may have a first slot side edge 42 and an opposing second slot side edge 44. The first and second slot side edges 42, 44 may be substantially parallel to one another. The first and second slot side edges 42, 44 may also be substantially parallel to the first and second edges 26, 28 of the caliper 20. The slot 40 may also have a bottom slot edge 46. The bottom slot edge 46 may be located between the first and second slot side edges 42, 44. More specifically, the bottom slot edge 46 may run a length between the first slot side edge 42 and the second the second slot side edge 44, defining an approximately rectangular area of absent or removed caliper material 36 from the caliper 20.

The bottom slot edge 46 may meet the first and second slot side edges 42, 44 at interior corners, which may have an approximately orthogonal angle. Correspondingly, the bottom slot edge 46 may be substantially parallel to the top and bottom edges 22, 24 of the caliper 20. In at least one embodiment, the length of the bottom slot edge 46, and thus the size of the slot 40, is adjustable.

As discussed above, the slot 40 may be used to measure an aquatic creature. The slot 40 may be defined by a slot depth 49 and a slot width 48. The slot depth 49 may be the distance from the opening in the top edge 22 of the caliper 20 to the bottom slot edge 46. The slot depth 49 may also correspond with a distance the first and second slot side edges 42, 44 extend into the interior of the caliper 20.

The slot 40 may also be defined by a slot width 48. The slot width 48 may be the distance between the first slot side edge 42 and the second slot side edge 44. The slot width 48 may also correspond with the length of the bottom slot edge 46 and/or the gap in the top edge 22 of the caliper 20.

A hole 34 may be included in the caliper 20. In an embodiment, as illustrated in FIG. 1, the hole 34 may be located on an end of the caliper 20 opposite to the slot 40. For example, if the slot 40 is located near the first 30 end of the caliper 20, the hole 34 may be located near the second end 32 of the caliper 20.

The hole 34 may be configured as any shape through which an object, such as a ring 72 or tether 60, may be passed. More specifically, and without limitation, the hole 34 may be circular, oval, square, rectangular, hexagonal, octagonal, otherwise polygonal, or virtually any other shape. An object may be passed through the hole 34. In one example, the object may be passed through the hole that may be attach or connect to a tether 60 and/or band 50 to create the lobster gauge 10.

As illustrated in FIG. 1, a ring 72 may be passed through the hole 34. The ring 72 may provide an anchoring point for another component of the lobster gauge 10, such as a tether 60, to be attached or connected to the caliper 20. If a ring 72 is included by the lobster gauge 10, it may be constructed using virtually any material. As an example, the ring 72 may be constructed using plastic or a metal, and may be resistant to corrosion. In one specific example, without limitation, the ring may be a coiled piece of metal such as a split ring. Alternatively, a different component of the lobster gauge may be passed through the hole directly, such as a tether 60.

The tether 60 will now be discussed in greater detail, along with FIGS. 1 and 3. The tether 60 may be included as a component of the lobster gauge to attach or secure the caliper 20 to an object or person. The tether 60 may be created using a piece of material. Example materials may include, but should not be limited to, cloths, ropes, strings, cords, or belts. The material may preferably be flexible, such to allow mobility of the caliper 20. Additionally, the material may be expandable and/or elastic. However, skilled artisans will appreciate alternative materials, which may be at least partially rigid, could be used consistent with the scope and spirit of the present invention.

The tether 60 may have a first tether end 62 and an opposing second tether end 66. The first and second tether ends 62, 66 may include a configuration that facilitates connection of the tether 60 to other components of the lobster gauge 10. For example, the first and/or second tether ends 62, 66 may provide a first and/or second loop 64, 68, respectively, as illustrated in FIGS. 1 and 3.

For example, the first loop 64 may be formed by bending or coiling the first tether end 62 around to be connected to a first intermediary section 65 of the tether 60, located between the first and second tether ends 62, 66. The first tether end 62 may be connected to the first intermediary section 65 using a clamp 70. The clamp 70 may be constructed using a corrosion resistant material, such as but not limited to, brass. Alternatively, the first tether end 62 may be connected to a first intermediary section 65 of the tether 60 using a different connection technique, such as a knot, welding, adhesion, or other form of connection.

Similarly, the second loop 68 may be formed by bending or coiling the second tether end 66 around to be connected to a second intermediary section 69 of the tether 60, located between the first and second tether ends 62, 66. The second tether end 66 may be connected to the second intermediary section 69 using a clamp 70. The clamp 70 may be constructed using a corrosion resistant material, such as but not limited to, brass. Alternatively, the second tether end 66 may be connected to a second intermediary section 69 of the tether 60 using a different connection technique, such as a knot, welding, adhesion, or other form of connection.

The first and second tether ends 62, 66 may be connected using the same or different techniques at each end. Additionally, the loops 64, 68 may be similar or different sizes at each of the ends.

The first tether end 62 or loop 64 may connect to the caliper 20. More specifically, a first loop 64 near the first tether end 62 may connect to the second end 32 of the caliper 20 directly through the hole 34 included by the caliper 20. Alternatively, a first loop 64 near the first tether end 62 may be connected to a ring 72, which may be connected to the caliper 20. If a ring 72 is to be included, the first loop 64 of the tether 60 may intermediately connect to a ring 72 that is connected to the hole 34 in the caliper 20. Inclusion of a ring 72 may provide additional mobility of the caliper 20. The second tether end 66 or loop 68 may connect to a band 50.

The band 50 will now be discussed in greater detail. As mentioned above, a band 50 may be connected to the tether 60 near its second tether end 66. The band 50 may be a piece of material that can be anchored, connected to, and/or worn by a user. For example, as illustrated in FIG. 1, the band 50 may be an approximately circular piece of rubber that can be slipped around the wrist of a wearer. Skilled artisans will appreciate that band 50 may be connected to objects other than a wrist, such as, without limitation, an ankle, garment, piece of equipment, object, or other extension of the wearer.

In additional embodiments, the band 50 may be configured differently than discussed above and pictured in FIG. 1. For example, the band 50 may be constructed using another material, such as a plastic, metal, or fabric. Also, the band 50 may be formed with a shape that, although not circular, would be consistent with the scope and spirit of the present invention. A connector may be included on the band 50, such as a latch or clip, to allow a wearer to easily attach the band 50 to his or her wrist, garments, or other equipment. In an embodiment, the band 50 may be constructed in various colors and designs, with graphics being printable on the band 50.

In operation, the lobster gauge may be used to measure the size of an aquatic animal. More specifically, the lobster gauge may be used to ensure that a lobster meets the regulation size to keep in a person's lobster bag. Skilled artisans will appreciate that the lobster gauge is not intended to be limited to the illustrative uses of this disclosure. The illustrative discussions relating to the measuring of a lobster are provided in the interest of clearly disclosing an embodiment of the invention.

To measure a lobster, a person may hold the lobster in one of his or her hands. The person may hold the lobster gauge in his or her other hand. As mentioned above, the lobster gauge may already be located near the hand of the person, since the band 50 may already be worn around the wrist of the person with the caliper 20 attached via the tether 60. The person may then apply the lobster gauge to a section of the lobster to ensure that section is of sufficient size to validly keep.

More specifically, to measure the lobster, the person may attempt to place the carapace of the lobster within the slot 40 of the caliper 20 to determine whether the lobster is valid and of sufficient size to keep. For example, if the carapace of the lobster fits entirely within the slot 40 of the caliper 20 and does not make contact with both the first and second slot edges 42, 44, the lobster may be insufficiently small and may have to be let go. Conversely, if the carapace of the lobster cannot fit within the slot 40 of the caliper 20, the lobster may be sufficiently large and valid to be added to the person's bag. Once the lobster has been measured, the user may release the lobster gauge 10 to hang from the user's wrist or other extension via the tether 60.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An apparatus for measuring a section of a creature comprising:
a caliper comprising a top edge and opposing bottom edge both extending from a first end of the caliper to a second end of the caliper, and caliper material extending from the top edge to the bottom edge being bound at the first end by a first side edge and at the second end by a second side edge;
a slot of caliper material that is absent from the caliper near the top edge defined by a slot width along part of the top edge partially extending into the caliper material of the caliper in the direction of the bottom edge to a slot depth and terminating at a bottom slot edge;
a band for anchoring the caliper;
a tether to connect the caliper and the band, the tether comprising a piece of tether material elongated between a first tether end and a distal second tether end, wherein the first tether end is connected to a first intermediary section of the tether to form a first loop that is connectable to the caliper, and wherein the second tether end is connected to a second intermediary section of the tether to form a second loop that is connectable to the band; and
a hole in the caliper to which the tether is connectable;
wherein the slot width is configurable respective to a desired length of the section of the creature.

2. The apparatus of claim 1, wherein the top edge is approximately parallel with the bottom edge.

3. The apparatus of claim 1, wherein the first side edge is approximately parallel with the second side edge.

4. The apparatus of claim 1, wherein the top edge is approximately parallel with the bottom edge, wherein the first side edge is approximately parallel with the second side edge, and wherein the top edge and the bottom edge are approximately orthogonal to the first side edge and the second side edge.

5. The apparatus of claim 4, wherein the top edge or the bottom edge intersect with the first side edge or the second side edge at a corner that is at least partially rounded.

6. The apparatus of claim 1, wherein the apparatus is constructed using corrosion resistant substances.

7. The apparatus of claim 1, wherein the slot width is adjustable.

8. The apparatus of claim 1, further comprising a ring that is passable through the first loop and the hole to connect the tether to the caliper.

9. The apparatus of claim 1, wherein the section is a carapace and the creature is an arthropod.

10. An apparatus for measuring a section of a creature comprising:
a caliper comprising a top edge and opposing bottom edge both extending from a first end of the caliper to a second end of the caliper, and caliper material extending from the top edge to the bottom edge being bound at the first end by a first side edge and at the second end by a second side edge, wherein the top edge is approximately parallel with the bottom edge, wherein the first side edge is approximately parallel with the second side edge, and wherein the top edge and the bottom edge are approximately orthogonal to the first side edge and the second side edge;
a slot of caliper material that is absent from the caliper near the top edge defined by a slot width along part of the top edge partially extending into the caliper material of the caliper in the direction of the bottom edge to a slot depth and terminating at a bottom slot edge;
a band for anchoring the caliper;
a tether to connect the caliper and the band; and
a hole in the caliper to which the tether is connectable;
wherein the slot width is configurable respective to a desired length of the section of the creature;
wherein the apparatus is constructed using corrosion resistant substances.

11. The apparatus of claim 10, wherein the tether comprises a piece of tether material elongated between a first tether end and a distal second tether end, wherein the first tether end is connected to a first intermediary section of the tether to form a first loop that is connectable to the caliper, and wherein the second tether end is connected to a second intermediary section of the tether to form a second loop that is connectable to the band.

12. The apparatus of claim 10, wherein the top edge or the bottom edge intersect with the first side edge or the second side edge at a corner that is at least partially rounded.

13. The apparatus of claim 10, wherein the slot width is adjustable.

14. The apparatus of claim 10, further comprising a ring that is passable through the first loop and the hole to connect the tether to the caliper.

15. A method for measuring a section of a creature using an apparatus that comprises a caliper with a slot, wherein the method comprises the steps of:
(a) positioning the creature adjacent to the caliper, wherein the caliper comprises a top edge and opposing bottom edge both extending from a first end of the caliper to a second end of the caliper, and caliper material extending from the top edge to the bottom edge being bound at the first end by a first side edge and at the second end by a second side edge;
(b) determining validity of the creature that has the section measured as equal to or greater than a slot width, wherein the slot is defined by the caliper material that is absent from the caliper at the top edge for the slot width along part of the top edge partially extending into the caliper material in the direction of the bottom edge to a slot depth and terminating at a bottom slot edge;
(c) keeping the creature that is valid; and
(d) releasing the creature that is not valid;
wherein the caliper is capable of being anchored via a band;
wherein the band is attachable to the caliper via a tether comprising a piece of tether material elongated between a first tether end and a distal second tether end, wherein the first tether end is connected to a first intermediary section of the tether to form a first loop that is connectable to the caliper, and wherein the second tether end is connected to a second intermediary section of the tether to form a second loop that is connectable to the band;
where a hole is comprised by the caliper to which the tether is connectable;
wherein the slot width is configurable respective to a desired length of the section of the creature indicative of validity.

16. The method of claim 15, wherein the top edge is approximately parallel with the bottom edge.

17. The method of claim 15, wherein the first side edge is approximately parallel with the second side edge.

18. The method of claim 15, wherein the apparatus is constructed using corrosion resistant substances.

19. The method of claim 15, wherein the slot width is adjustable.

20. The method of claim 15, further comprising a ring that is passable through the first loop and the hole to connect the tether to the caliper.
